(19) United States
(12) Patent Application Publication
(10) Pub. No.: US 2014/0304636 A1
(43) Pub. Date: Oct. 9, 2014

(54) VEHICLE'S INTERACTIVE SYSTEM

(71) Applicant: QOROS AUTOMOTIVE CO., LTD, Changshu, Jiangsu (KR)

(72) Inventors: Markus Andreas Boelter, Changshu (CN); Zi Yun, Changshu (CN); Yilin Liu, Changshu (CN); Linying Kuo, Changshu (CN); Leizhong Zhang, Changshu (CN)

(73) Assignee: QOROS AUTOMOTIVE CO., LTD., Changshu, Jiangsu (CN)

(21) Appl. No.: 14/241,888

(22) PCT Filed: Aug. 31, 2011
(86) PCT No.: PCT/CN2011/079210

§ 371 Date: Jun. 6, 2014

(51) Int. Cl. G06F 3/0488; G06F 3/0481

(52) U.S. Cl. CPC G06F 3/0488; G06F 3/0481
USPC 715/771

(57) ABSTRACT

Embodiments of the present inventive concepts relate to a method for allowing a user to control applications of a vehicle via an interactive system with a touch-sensitive screen having an input area. The method may include displaying a first representation of a first application in a first edge region of the touch-sensitive screen, displaying a second representation of a second application in a main area of the touch-sensitive screen, and replacing display of the second representation of the second application in the main area with a display of the first representation of the first application when a first type of finger gesture is detected. The first type of finger gesture may be detected when fingers have moved in a predetermined direction on the screen.

### FIELD

Embodiments of the present inventive concepts relate to a vehicle's interactive system, and more particularly, to a vehicle's interactive system that distinguishes between different types of finger gestures of a user.

### BACKGROUND

Many vehicles are nowadays provided with a large number of applications. For example, passenger cars are often provided with radio, MP3 player, TV, navigation system, telephone, etc. In order to facilitate control, a single interface device may be present in the vehicle by which different applications may be controlled. For example, the control of a radio and the setting of the car's air conditioning unit may be controlled via the same interface device.

Such interface devices may use different types of actuators such as hard keys, buttons, joysticks, etc., for user input. Interface devices relying on such actuators often suffer from the drawback that the actuators are associated with different functions and operation is thus complicated and needs full attention by the user. The user, however, is usually driving the car and may not be able to focus on operation of the interface device.

To simplify operation, in WO 2010/142543 A1, an interface device with a touch screen is disclosed. On the touch screen, a menu including several objects is shown, the objects being associated with global input gestures. Independently from the content currently visible on the touch screen, a function is executed when a corresponding one of the global input gestures is detected. The global input gestures may comprise a user writing a number on the touch screen with his finger. The device then executes a function of the menu corresponding to that number.

However, the user still needs to capture the currently shown menu while driving, find the desired function, determine the number that the desired function corresponds to and then make a complicated handwriting gesture on the touch screen.

### SUMMARY

Embodiments of the present inventive concepts provide a way of navigating applications of a vehicle that is intuitive, quick, and easy and minimizes distraction for the driver. Further, a multiple touch control technique enables differentiation of a local control (e.g., point touch) and global control (e.g., single swipe), thus enabling switch display or operation from one application to another application.

Methods, apparatuses, computer-readable medium, and interactive systems in accordance with various embodiments of the inventive concept are provided and disclosed herein. In particular, a method for allowing a user to control applications of a vehicle via an interactive system with a multiple touch-sensitive screen having an input area is provided. The method may include displaying a first representation of a first application in a first edge region of the touch-sensitive screen, displaying a second representation of a second application in a main area of the touch-sensitive screen, and replacing display of the second representation of to the second application in the main area with a display of the first representation of the first application when a first type of finger gesture is detected. The first type of finger gesture may include a finger movement along one or more lines toward the first edge region or away from the first edge region.

Representations displayed in edge regions of the screen are dedicated to specific applications. By a simple swipe towards one of the representations, the user can cause the system to open the corresponding application in the main area. Further, as the representations are displayed at the edge regions, the user easily sees where his gesture should be directed and may quickly call the application by swiping his fingers towards said representation without having to navigate through any menus. The representations may be located directly at the edges of the display. As a user can feel the edge of the screen, it is possible for the user to perform the application change “blindly” without looking at the screen. In some embodiments, two or more representations of applications may be displayed in the same edge region. In some embodiments, one or more representations are displayed at a straight edge section of the display. Moreover, the main area may be identical to or lie entirely within the input area of the screen.

In some embodiments, the method further comprises starting the first application when the first type of finger gesture is detected. This is useful, in particular, if the first application is not already running in the background.

According to some embodiments, displaying a representation of an application in an edge region of the touch-sensitive screen comprises displaying a bar, a circle or other geometric shape, preferably extending along said edge region or an edge of the screen, and/or a tag in said edge region. The bar or tag provides the user with a clear indication of the direction into which the first type of finger gesture should follow in order to cause display of a representation of the desired application. The tag may, in particular, comprise a short-cut name and/or a symbol of the associated application. This helps the user to identify which application can be called by a gesture performed in that direction. The representation displayed in the edge region may have a different color than a portion of the main area surrounding the representation.

The finger movement may comprise a movement on the screen. The first type of finger gesture may comprise a contact between a finger of the user and the touch-sensitive screen at a contact position and moving said contact position along a line by moving the finger. The line starts at a contact position at which the finger first touches the screen and ends at a position at which the finger ceases to touch the screen, while there is an uninterrupted or substantially to uninterrupted contact between the finger and the screen along the line.

In some embodiments, the first type of finger gesture is detected only if the finger movement is in the main area. By restricting the finger movement to the main area, the edge regions may still be used for other gestures, e.g. to control applications represented in a particular region. In some embodiments, the first type of finger gesture is detected only if the finger movement results in a contact line with the screen that is entirely in the main area. This avoids misinterpretation of the user input if the gesture extends over both the main area and an edge region.

In some embodiments, the finger movement includes moving at least two fingers substantially along lines toward the first edge region. The finger movement may be performed in the main area. Providing for the use of a two-finger gesture is preferred as single-finger gestures may still be used to call functions associated with objects shown in the main area. Moreover, in this embodiment, the main area is used both for displaying the representation of one of the applications and for inputting finger gestures. In some embodiments, said moving at least two fingers is detected if contact positions of the fingers with the screen have a minimum spacing of about 10 millimeters (mm), in particular, about 15 mm and, preferably, about 20 mm.

According to some embodiments, the first type of finger gesture is detected when a speed and/or a distance of the finger movement meet predetermined values. This avoids undesired displaying of applications due to the user's finger involuntarily contacting the screen when the vehicle is moving. Requiring a predetermined distance further avoids false interpretation of short finger gestures by which the user might otherwise wish to actuate functions associated with the main area. According to some embodiments, the first type of finger gesture is detected only if the gesture results in a contact line on the screen that is between 2 mm and 100 mm, in particular, between 3 mm and 60 mm and, preferably between 5 mm and 50 mm in length. Such a length allows the ability to clearly distinguish between a swiping gesture and a static, point-like gesture. This is especially advantageous if the system also provides for static gestures to be used, e.g., to call functions associated with objects in the main area, as set forth below.

In some embodiments, the first type of finger gesture is detected only when the finger movement results in a line that has a length of at least 5%, in particular at least about 10% and preferably at least 20% of a smallest dimension or a diameter of the screen. In some embodiments, the first type of finger gesture is detected when fingers have moved in a predetermined direction on the screen.

In some embodiments, the second application is replaced only if said gesture results in a straight contact line on the screen. In contrast to gestures resulting in contact lines on the screen that have curves or corners, for a substantially straight contact line, its direction can be easily determined Here, the term substantially straight may comprise a radius of curvature of more than about 20 mm, in particular more than about 50 mm and, preferably more than about 100 mm Alternatively or additionally, the term substantially straight may comprise a ratio of a radius of curvature of a contact line to a length of the contact line of more than one, in particular, more than three and, preferably more than ten.

According to some embodiments, at least one of the first and second applications is a navigation application, an entertainment application, a communication application or a car-information application. Displaying the application in the main area may comprise displaying at least one object associated with said application in the main area. The at least one object may, e.g., be an object associated with a function of the application, a pictogram, a button, and/or an object presenting information associated with the application.

In some embodiments, the method may further comprise, when displaying the first and/or second representation in the main area displaying, in the main area, at least one object in an object area associated with a function of the respective application displayed in the main area. The method may further comprise executing the function associated with the object when a second type of finger gesture different from the first type of finger gesture is detected.

This embodiment further allows for functions to be called by the user via the main area. The object shown in the main area may, e.g., comprise a symbol or a name of the function. It is preferred that the second type of finger gesture is a one-finger movement, e.g., a one-finger swipe or a one-finger static gesture. A static gesture is a gesture that results in an essentially non-moving contact position on the screen.

Said execution may comprise transmitting, via a bus connector of the interactive system, a trigger signal to an execution unit associated with said function. In this embodiment, the execution unit may be external to the interactive system. The interactive system may thus be replaced without having to replace the execution units as well. Further, communication via a communication bus is preferred for better compatibility with a variety of execution units. Alternatively, one or more execution units may be integral to the interactive system as set forth below.

In some embodiments, each application may be associated with a different execution unit. The interactive system may be connected, via said communication connection, to a to plurality of execution units. Each execution unit may be adapted to execute functions associated with a respective one of said applications. The execution units may comprise, e.g., an entertainment unit, a communication unit, a navigation unit, and/or a car information unit. The entertainment unit may further comprise a radio, a CD player, and/or an mp3 player. The car information unit may, e.g., comprise a climate control unit.

According to a some embodiments, the method may further comprises displaying at least one, preferably three additional representations of respective applications in respective edge regions of the touch-sensitive screen, and replacing display of the second representation of the second application in the main area with a display of one of the additional representations when a first type of finger gesture toward a respective one of the edge regions is detected on the screen. Various applications may be opened by the user by swiping his fingers into a corresponding direction on the screen. Hence, the user is provided with the possibility to control a variety of applications by simple gestures. The representations may, in particular, be associated with different applications. Alternatively, two or more of the representations may be associated with the same application.

According to some embodiments, the method further comprises generating and/or sending an acoustic notification when the first type of finger gesture toward the first edge region is detected. In this embodiment, the user is acoustically informed that the application is replaced in the main area. This step may comprise sending a different acoustic notification based on the application now displayed in the main area. For example, a beep of different frequency may be produced for different applications now displayed in the main menu. The user is thus informed of which application is displayed without having to look at the screen.

In a further aspect, embodiments of the present inventive concepts provide a computer-readable medium containing instructions that when executed by an interactive system of a vehicle with a touch-sensitive screen cause the interactive system to perform a method of the aforementioned kind.

In a still further aspect, an interactive system for controlling vehicle applications adapted to display a plurality of applications in a main area and at least two edge regions of the touch-sensitive screen and actuate functions of the applications by a user input is provided, comprising a touch-sensitive screen configured to differentiate between a first type of finger gesture and a second type of finger gesture and replace a display of a representation of a second application in the main area of the touch-sensitive screen with display of a representation of a first application previously displayed in a first edge region when the first type of finger gesture is detected, wherein the first type of finger gesture includes a finger movement along lines toward the first edge region, and wherein the main area extends over an entire area of the screen not covered by the edge region.

In particular, the main area may extend over an entire area of the screen not covered by the at least two edge regions. In some embodiments, a substantially entire main area of the touch-sensitive screen is responsive to the first type of finger gesture. Hence, a user is capable of performing the first type of gesture without a need of visual observation of the touch-sensitive screen while accomplishing a desired control correctly.

In some embodiments, the first type of finger gesture is detected when two fingers have moved a predetermined distance on the touch-sensitive screen toward a direction of the first edge region.

According to some embodiments, the touch-sensitive screen is further configured to actuate a selected function of an application when a second type of finger gesture is detected, wherein the second type of finger gesture is different from the first type of finger gesture. In some embodiments, the second type of finger gesture is a one-finger static contact with the touch-sensitive screen or a one-finger swipe over a distance in the touch-sensitive screen.

The interactive system is adapted to control applications of the vehicle. In particular, the interface device may have a bus connector for connecting to a communication bus of the vehicle. Embodiments of the inventive concepts further provide an interactive system for controlling vehicle applications with a touch-sensitive screen adapted to perform a method of the aforementioned kind.

In an embodiment, the touch-sensitive screen comprises an LCD, an LED, in particular an OLED, and/or a multi-color display unit. Further, a touch-sensitive panel that enables precise and prompt identification of multi-touch gestures may be used. In one example, the touch-sensitive screen may be a capacitive screen. Such display units are easy to manufacture, reliable and consume little energy. This is especially advantageous in the context of using the interface unit in a vehicle.

In some embodiments, the interactive system further has means for fixedly installing said system to said vehicle, in particular, into a dashboard of said vehicle. This allows for a steady position of the interactive system relative to the driver, such that he can easily locate the screen. The means for fixedly installing may, e.g., comprise a threading, one or more screw holes, and/or one or more clamps.

In a further aspect, embodiments of the present inventive concepts provide a motor vehicle, in particular, a passenger car, a truck, a motor boat, a plane, or the like, comprising an interactive system of the aforementioned kind.

### SHORT DESCRIPTION OF DRAWINGS

FIG. 1 shows a schematic block diagram of an interactive system according to embodiments of the present inventive concepts.

FIG. 2 shows a display of the screen of the interactive system according to embodiments of the present inventive concepts with a first screen configuration.

FIG. 3 shows a display of the screen of the interactive system according to embodiments of the present inventive concepts with a second screen configuration.

FIG. 4 shows a display of the screen of the interactive system according to embodiments of the present inventive concepts with a third screen configuration.

FIG. 5 shows an interactive system according to embodiments of the inventive concepts.

The foregoing and other features of the inventive concepts will become more readily apparent from the following detailed description, which proceeds with reference to the accompanying drawings.

### DETAILED DESCRIPTION

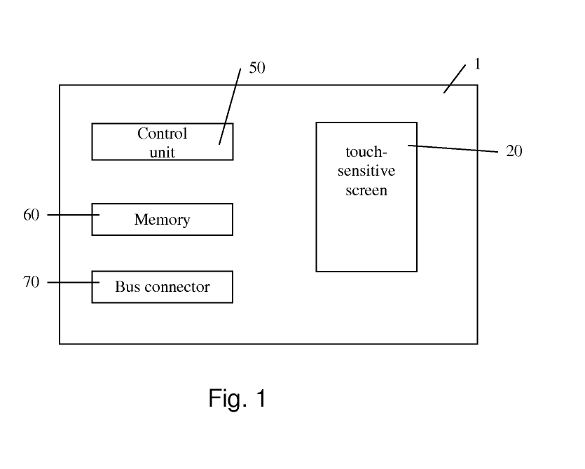

FIG. 1 shows a schematic block diagram of an embodiment of an interactive system. The system 1 comprises a touch-sensitive screen 20, a control unit 50, a memory 60 and a bus connector 70. The control unit 50 is connected to the memory 60 and is further adapted to execute a program stored in the memory 60. Further, the control unit 50 is connected to the screen 20. The control unit 50 controls a display of the screen 20 and is further adapted to receive input from a user via the screen 20. In addition, the control unit 50 is connected to the bus connector 70 by which the system 1 may be connected to a vehicle bus.

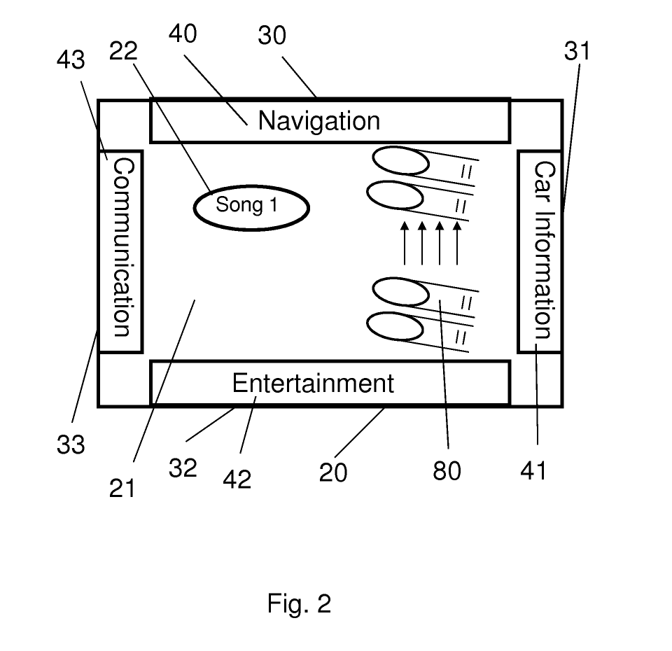

FIGS. 2-4 show a display of the screen of the interactive system 1 according to embodiments of the present inventive concepts with different applications displayed in a main area 21 of the screen. The display of the rectangular touch-sensitive screen 20 has a main area 21. In some embodiments, only one representation of an application at a time is displayed in the main area 21. In FIG. 2, a representation of an entertainment application is displayed in the main area 21, comprising an object 22 associated with a song. The object 22 associated with the song may be in an MP3 play list, for example. If the user touches the object 22 with his or her finger in a static manner, the interactive system 1 executes playing of the respective song.

At each edge 30, 31, 32, and 33 of the screen 20, a respective representation 40, 41, 42, and 43 of a respective application is displayed. Each representation 40-43 may include a bar containing a tag associated with the respective application. In more detail, in the upper edge region, a representation 40 of a navigation application is displayed. In the right edge region, a representation 41 of a car information application is displayed. In the lower edge region, a representation 42 of an entertainment application is displayed. And in the left edge region, a representation 43 of a communication application is displayed.

Upon detecting one or more gestures, the system may cause a change of the display in the main area 21 from the representation of one application to the representation of another application. The one or more finger gestures may include two-finger touch, three-finger touch, four-finger, and/or five-finger touch on the touch-sensitive screen in a predetermined pattern recognizable by the interactive system. In one example, the predetermined pattern may be a finger touch pattern that is easily performed by a user. For example, a two-finger gesture may include a two-finger swipe in different directions. In particular, a two-finger swipe upward as indicated by reference number 80 in FIG. 2 may switch the main area 21 to a display of a representation of the navigation application. Similarly, a two-finger swipe downward may switch to the display of a representation of the entertainment application. A two-finger swipe to the left may switch to the display of a representation of the communication application. And a two-finger swipe to the right may switch to the display of a representation of the car information application. That is, the main area 21 of the screen 20 supports multiple gesture control.

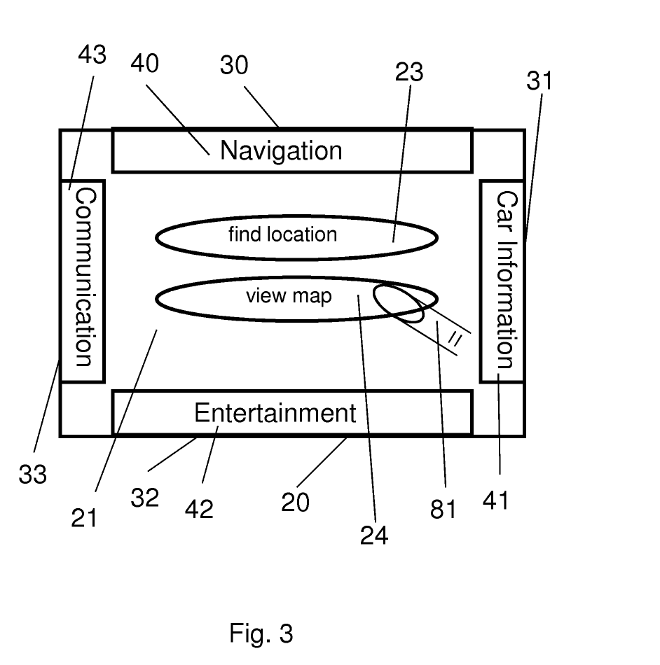

Single-finger gestures in the main area 21 may cause execution of a function within an application, while a two-finger gesture may cause switching between different applications being displayed in the main area 21. In one example, the two-finger movement illustrated in FIG. 2 may cause the display of navigation application in the main area 21 to replace the previously displayed entertainment application as shown in FIG. 3 and as further described below.

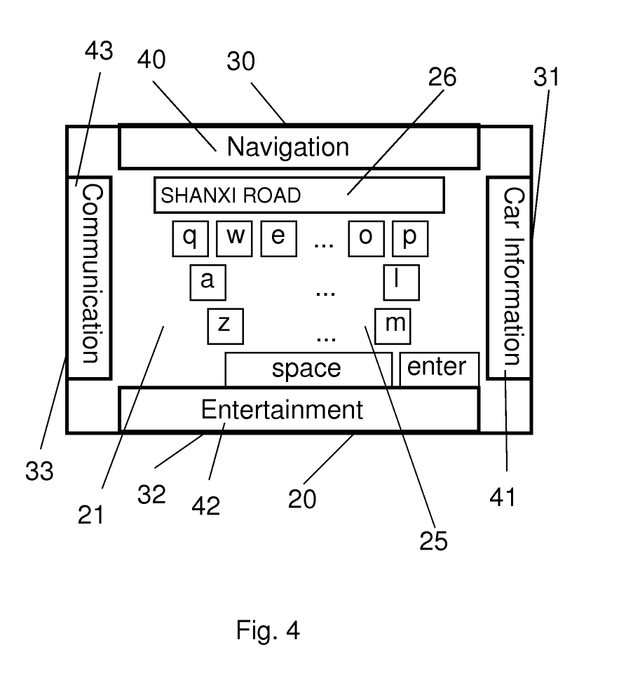

Reference is now made to FIGS. 3 and 4. In FIG. 3, the main area 21 of the screen 20 is displaying a representation of the navigation application. Selecting “find location” 23 shown in the main area 21 by a one-figure gesture may actuate a display of a key board 25 in the main area 21 (see FIG. 4) to allow an entry of a destination in a location field 26 displayed in the main area 21 to get a direction. Further, selecting “view map” 24 in the main area 21 as indicated by finger 81 causes the system 1 to display a map in the main area 21. Similarly, a user can select a different menu level or execute a function in the entertainment application, communication application, car information application and other application of the interactive system if one of such applications is displayed in the main area 21.

A two-finger gesture on the main area 21 may, regardless of the application being currently displayed in the main area 21, cause replacing the representation of the application in the main area 21 with a representation of a different application.

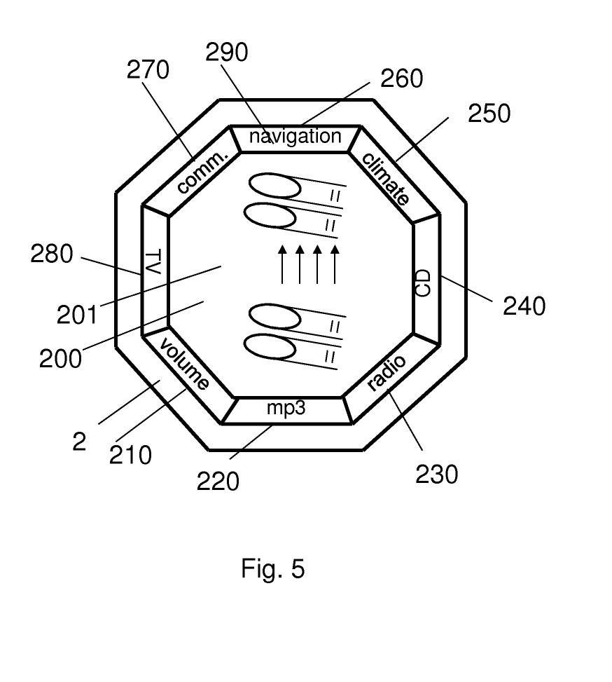

FIG. 5 shows an embodiment of the interactive system. The interactive system 2 comprises a touch-sensitive screen 200, which can be octagonal. Screen 200 has a main area 201. At each edge (i.e., 210, 220, 230, 240, 250, 260, 270, and 280) of the screen 200, a representation of a respective different application is displayed, of which in FIG. 5 only one representation is exemplarily referenced by reference number 290. By a two-finger sweeping gesture towards one of the edge regions, the respective application is displayed in the main area 201. The interactive system 2 is adapted to distinguish between two-finger sweeping gestures directed towards the eight individual edge regions. As described in more detail with regard to the embodiments of FIGS. 2-4, the main area 201 may show a number of objects in corresponding object areas. The user may call functions of the application displayed in the main area 201 by a one-finger gesture on one of said objects.

Further modifications of the described embodiments are possible without leaving the scope of embodiments of the present inventive concepts, which is defined by the enclosed claims. For example, the representation displayed in the edge regions may comprise a current status of the corresponding application. In some embodiments, in one edge region, two edge regions or three edge regions, representations of applications are displayed while the rest of the edge regions are reserved for other purposes.

1. A method for allowing a user to control applications of a vehicle via an interactive system associated with a touch-sensitive screen having, the touch-sensitive screen including an input area, the method comprising:
displaying a first representation of a first application in a first edge region of the touch-sensitive screen;
displaying a second representation of a second application in a main area; of the touch-sensitive screen; and
replacing display of the second representation of the second application in the main area with a display of the first representation of the first application when a first type of finger gesture is detected, wherein the first type of finger gesture is detected when fingers have moved in a predetermined direction on the screen.

2. The method of claim 1, wherein the first type of finger gesture is detected only if the finger movement is in the main area.

3-19. (canceled)

20. The method of claim 1, wherein the finger movement includes moving at least two fingers substantially along lines toward the first edge region or away from the first edge region, and the finger movement is performed in the main area.

21. The method of claim 1, wherein:
the first type of finger gesture is detected only if the finger movement is in the main area; and
the finger movement includes moving at least two fingers substantially along lines toward the first edge region and the finger movement is performed in the main area.

22. The method of claim 1, wherein the finger movement includes moving multiple fingers in a predetermined pattern in the main area.

23. The method of claim 1, wherein the first type of finger gesture is detected when at least one of speed or distance of the finger movement meet predetermined values.

24. The method of claim 1, wherein the first type of finger gesture is detected when fingers have moved in a predetermined direction on the screen for a pre-determined distance.

25. The method of claim 1, wherein the first type of finger gesture is detected only when the finger movement results in a contact line on the screen that has a length of at least one of (i) 5%, (ii) at least about 10%, or (iii) at least 20% of a smallest dimension of the screen.

26. The method of claim 1, wherein the first type of finger gesture is detected only if it results in a substantially straight contact line on the screen.

27. The method of claim 1, wherein displaying at least one of the first or second representation in the main area comprises:
displaying, on the main area, at least one object in an object area associated with a function of the respective application displayed in the main area;
and the method further comprises:
executing the function associated with the object when a second type of finger gesture different from the first type of finger gesture is detected.

28. The method of claim 27, wherein the second type of finger gesture is a one-finger movement.

29. The method of claim 27, wherein said executing comprises transmitting, via a bus connector of the interactive system, a trigger signal to an execution unit associated with said function.

30. The method of claim 1, further comprising:
displaying at least one additional representations of respective applications in respective edge regions of the touch-sensitive screen; and
replacing display of the second representation of the second application in the main area with a display of one of the additional representations when a first type of finger gesture toward a respective one of the edge regions is detected on the screen.

31. The method of claim 1, further comprising:
generating an acoustic notification when the first type of finger gesture toward the first edge region is detected.

32. A computer-readable medium containing instructions that when executed by an interactive system of a vehicle with a touch-sensitive screen cause the interactive system to perform the method of claim 1.

33. An interactive system for controlling vehicle applications adapted to display a plurality of applications in a main area and at least two edge regions of a touch-sensitive screen, and actuate functions of the applications by a user input, the system comprising:
a touch-sensitive screen configured to differentiate between a first type of finger gesture and a second type of finger gesture, and to replace a display of a representation of a second application in the main area of the touch-sensitive screen with display of a representation of a first application previously displayed in a first edge region when the first type of finger gesture is detected,
wherein the first type of finger gesture is detected when fingers have moved in a predetermined direction on the screen, and the main area extends over an entire area of the screen not covered by the edge region.

34. The interactive system of claim 33, wherein substantially an entire main area of the touch-sensitive screen is responsive to the first type of finger gesture so that a user is capable of performing the first type of gesture without a need of visual observation of the touch-sensitive screen.

35. The interactive system of claim 33, wherein the first type of finger gesture is detected when two fingers have moved a predetermined distance on the touch-sensitive screen toward a direction of the first edge region or away from the direction of the first edge region.

36. The interactive system of claim 33, wherein the touch-sensitive screen is further configured to actuate a selected function of an application when a second type of finger gesture is detected, wherein the second type of finger gesture is different from the first type of finger gesture.

37. The interactive system of claim 36, wherein the second type of finger gesture is at least one of (i) a one-finger static contact with the touch-sensitive screen or (ii) a one-finger swipe over a distance in the touch-sensitive screen.
